(19) United States
(12) Patent Application Publication
(10) Pub. No.: US 2023/0258765 A1
(43) Pub. Date: Aug. 17, 2023

(54) PROTECTION STRUCTURE OF OBJECT DETECTION DEVICE OF VEHICLE

(71) Applicant: Honda Motor Co., Ltd., Tokyo (JP)

(72) Inventors: Shingo NAKAYAMA, Tokyo (JP); Takato WATANABE, Tokyo (JP); Hideaki AIZAWA, Tokyo (JP)

(73) Assignee: Honda Motor Co., Ltd., Tokyo (JP)

(21) Appl. No.: 18/079,796

(22) Filed: Dec. 12, 2022

(30) Foreign Application Priority Data
Feb. 17, 2022 (JP) 2022-022732

(51) Int. Cl. G01S 7/02; G01S 13/931

(52) U.S. Cl. CPC G01S 7/027; G01S 13/931; G01S 2013/93275

(57) ABSTRACT

The disclosure provides a protection structure of an object detection device of a vehicle. The protection structure includes: a bumper provided in a first direction, which is an object detection direction with respect to a radar device attached to a vehicle body frame via a support member; and a cover member covering the radar device. The cover member includes: a base part connected to the bumper; and an extension part extending from the base part in a second direction opposite to the first direction. The extension part is configured to abut on the vehicle body frame before the base part contacts the radar device or the support member in response to the bumper being displaced in the second direction due to an action of an external force.

### CROSS-REFERENCE TO RELATED APPLICATION

This application claims the priority benefit of Japan application serial no. 2022-022732, filed on Feb. 17, 2022. The entirety of the above-mentioned patent application is hereby incorporated by reference herein and made a part of this specification.

### BACKGROUND

### Technical Field

The disclosure relates to a protection structure for protecting an object detection device such as a radar device for detecting objects around a vehicle from impact during a light collision of the vehicle. Related Art

In recent years, the development of technology that contributes to vehicle collision avoidance and collision impact mitigation by installing a radar device, which is an object detection device that detects objects, in a vehicle and detecting obstacles in front of the vehicle with the radar device is in progress. For example, the technology disclosed in Patent Literature 1 is known as an example of mounting such a radar device on a vehicle.

Patent Literature 1 discloses an in-vehicle structure of a radar module that includes an exterior component (lower grille) disposed outside the vehicle body relative to the radar module, and a protection cover that is attached to the exterior component and covers the radar transmitting/receiving surface of the radar module. In this structure, a locking structure for locking the protection cover to the exterior component is provided between the exterior component and the protection cover. This locking structure is also a structure that releases the locking of the protection cover to the exterior component by receiving the load caused by the contact between the radar module and the protection cover due to the external force from the outside of the vehicle body; as a result, the radar cover comes into contact with a radar bracket at the time of a light vehicle collision, and the locking between the radar cover and the exterior component is released.

### CITATION LIST

### Patent Literature

[Patent Literature 1] Japanese Patent Application Laid-Open No. 2021-25849

However, in the structure described in Patent Literature 1, since the contact of the radar cover with the radar bracket cannot be avoided at the time of a light vehicle collision, when the radar cover comes into contact with the radar bracket, the radar bracket may become displaced or distorted. In addition, there is a risk that a strong impact may be applied to the radar device supported by the radar bracket. If the radar bracket is displaced or distorted, or if a strong impact is applied to the radar device, the object detection performance of the radar device may be affected, and it will be necessary to take measures such as maintenance of the radar device and replacement of components.

In view of the above, the disclosure provides a protection structure of an object detection device of a vehicle which, with a simple configuration that reduces the number of components, is capable of preventing a support member that supports the object detection device from being displaced or distorted at the time of a light vehicle collision and is also capable of preventing a strong impact from being applied to the object detection device.

### SUMMARY

In view of the above, a protection structure of an object detection device of a vehicle according to the disclosure includes: the object detection device (30) attached to a vehicle body frame (10) via a support member (20); an exterior component (40) of the vehicle provided in a first direction, which is an object detection direction by the object detection device (30) with respect to the object detection device (30); and a cover member (50) connected to the exterior component (40) and covering at least a part of the object detection device (30). The cover member (50) includes: a base part (51) provided in the first direction with respect to the object detection device (30); and an extension part (52) extending from the base part (51) in a second direction opposite to the first direction. A gap (S1) in the second direction from the base part (51) to the object detection device (30) is configured to be larger than a gap (S2) in the second direction from an end (52a) of the extension part (52) in the second direction to the vehicle body frame (10) (S1>S2). The extension part (52) is configured to abut on the vehicle body frame (10) in response to the exterior component (40) being displaced in the second direction with respect to the vehicle body frame (10) due to an action of an external force.

### BRIEF DESCRIPTION OF THE DRAWINGS

FIG. 1 is a schematic view showing a part of the front end of a vehicle including a protection structure of an object detection device (radar device) according to an embodiment of the disclosure.

FIG. 2 is a schematic view of a position corresponding to the X-X arrow in FIG. 1, and is a view showing a radar device attached to a vehicle body frame and a cover member connected to a bumper.

FIG. 3 is a partially enlarged view of the Y part of FIG. 1.

FIG. 4 is a view for illustrating the operation of the protection structure of the radar device, and is a view showing a state immediately before a light collision.

FIG. 5 is a view for illustrating the operation of the protection structure of the radar device, and is a view showing a state at the time of impact in a light collision.

FIG. 6 is a view for illustrating the operation of the protection structure of the radar device, and is a view showing a state at the time of maximum displacement of the bumper in a light collision.

FIG. 7 is a view for illustrating the operation of the protection structure of the radar device, and is a view showing a state immediately after a light collision.

### DESCRIPTION OF THE EMBODIMENTS

According to the protection structure of the object detection device of the vehicle according to the disclosure, when an exterior component of the vehicle is displaced in the second direction with respect to the vehicle body frame due to the action of an external force, the extension part of the cover member abuts on the vehicle body frame before the base part of the cover member that covers at least a part of the object detection device contacts the object detection device or the support member. With this configuration, even if the exterior component is displaced due to the action of an external force due to a light collision of the vehicle or the like, it is possible to effectively prevent other members from contacting the object detection device or the support member. Therefore, it is possible to prevent the support member that supports the object detection device from being displaced or distorted at the time of a light vehicle collision and to prevent a strong impact from being applied to the object detection device with a simple configuration that reduces the number of components.

Further, in this protection structure of the object detection device of the vehicle, a length (L1) of the extension part (52) may be longer than a length (L2) from the vehicle body frame (10) to an end (30a) on the base part (51) side of the object detection device (30) (L1>L2).

According to this configuration, when the exterior component of the vehicle is displaced in the second direction with respect to the vehicle body frame, the extension part may abut on the vehicle body frame before the base part of the cover member contacts the object detection device or the support member. Therefore, it is possible to more effectively prevent other members from contacting the object detection device or the support member with a relatively simple configuration.

Further, in this protection structure of the object detection device of the vehicle, connection between the exterior component (40) and the base part (51) of the cover member (50) may be released when the extension part (52) abuts on the vehicle body frame (10) in response to the exterior component (40) being displaced in the second direction.

According to this configuration, even if the exterior component is displaced by an external force due to a light collision of the vehicle, the amount of displacement of the cover member may be suppressed by releasing the connection between the exterior component and the base part of the cover member. Therefore, it is possible to more effectively prevent the cover member from contacting the object detection device or the support member.

Further, in this protection structure of the object detection device of the vehicle, a connection part (61) that connects the exterior component (40) and the base part (51) of the cover member (50) may be a part configured to be broken in response to the exterior component (40) and the base part (51) of the cover member (50) being relatively displaced by a predetermined amount or more.

According to this configuration, when the exterior component and the base part of the cover member are relatively displaced by a predetermined amount or more, the connection part connecting them is broken. Therefore, it is possible to more reliably prevent the cover member from contacting the object detection device or the support member even when the exterior component is displaced by an external force due to a light collision of the vehicle.

Further, in this protection structure of the object detection device of the vehicle, the extension part (52) may abut on at least a part of surroundings of the object detection device (30) and the support member (20) on the vehicle body frame (10).

According to this configuration, the extension part abuts on at least a part of the surroundings of the object detection device and the support member on the vehicle body frame, whereby it is possible to more reliably prevent the extension part and the base part of the cover member from contacting the object detection device and the support member.

Further, in this protection structure of the object detection device of the vehicle, the cover member (50) may be provided at a position above a load input part (A) to the exterior component (40) in a light collision test of the vehicle.

According to this configuration, since the cover member is provided at a position above the load input part to the exterior component in a light collision test of the vehicle, it is possible to effectively reduce the possibility that an external force acts directly on the cover member at the time of an actual light collision of the vehicle. Therefore, it is possible to more reliably prevent the cover member from contacting the object detection device or the support member.

Further, in this protection structure of the object detection device of the vehicle, the extension part (52) of the cover member (50) may be a tubular part disposed around the support member (20) and the object detection device (30).

According to this configuration, since the object detection device and the support member are surrounded by the extension part of the cover member, the object detection device and the support member may be effectively protected by the cover member. Therefore, even if the exterior component is displaced by an external force due to a light collision of the vehicle, it is possible to more reliably prevent other members from contacting the object detection device or the support member. In addition, the extension part of the cover member may be expected to have the effect of preventing the cover member, which has been separated from the exterior component, from completely detaching from the vehicle body and falling off at the time of a light collision of the vehicle.

Further, in this protection structure of the object detection device of the vehicle, the exterior component (40) may be a bumper of the vehicle, and at least a part of the cover member (50) may be disposed inside an opening (41) or a notch provided in the bumper (40), and may configure a part of the bumper (40).

According to this configuration, since the cover member that covers the object detection device configures a part of the bumper, even if the object detection device is disposed at a position at the same height as the bumper (a relatively lower position on the vehicle), it is possible to prevent other members from contacting the object detection device and the support member due to the impact of a light collision; therefore, it is possible to dispose the object detection device at a position closer to the bumper (especially a position where the distance in the front-rear direction of the vehicle body is shorter). Therefore, it is possible to improve the design of the vehicle body including the bumper and improve the object detection performance of the object detection device while maintaining the structure that may effectively protect the object detection device and the support member at the time of a light collision of the vehicle.

It should be noted that the above numerals in parentheses indicate the drawing reference numerals of corresponding components in the embodiments described later, for reference.

According to a protection structure of an object detection device of a vehicle of the disclosure, it is possible to prevent a support member that supports the object detection device from being displaced or distorted at the time of a light vehicle collision and to prevent a strong impact from being applied to the object detection device with a simple configuration that reduces the number of components.

Hereinafter, embodiments of the disclosure will be described in detail with reference to the accompanying drawings. It should be noted that the term “forward” in the following description refers to the forward direction (orientation) of the vehicle body (vehicle), which will be described later. Further, left and right refer to the left and right respectively when the vehicle body (vehicle) faces the forward direction (front side).

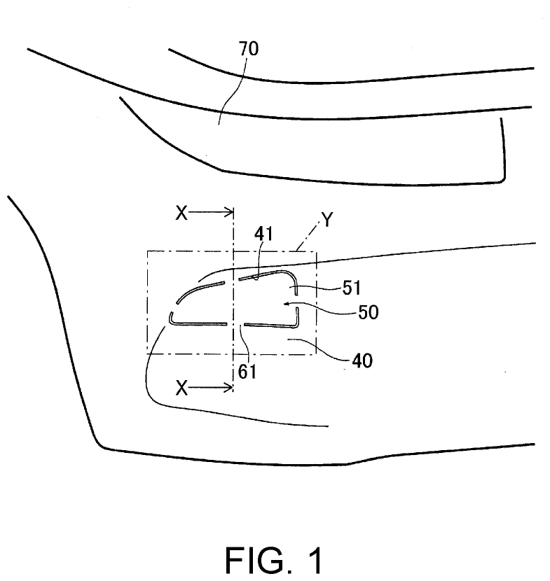

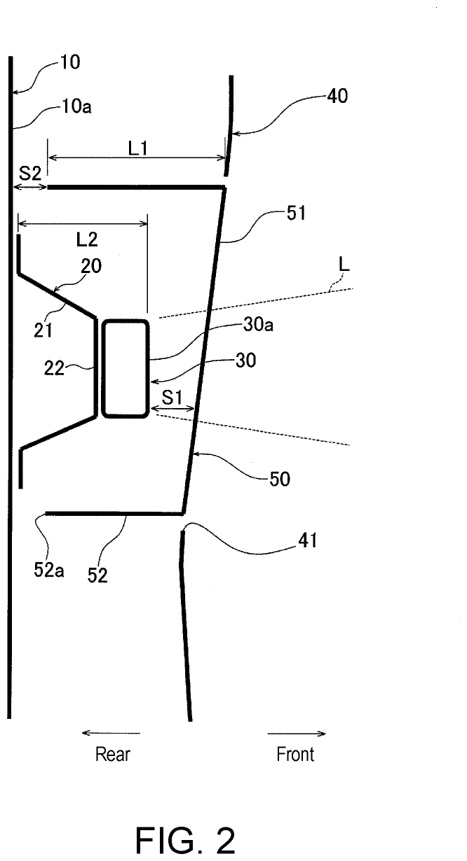

FIG. 1 is a schematic view showing a part of the front end of a vehicle body including a protection structure of an object detection device according to an embodiment of the disclosure. Further, FIG. 2 is a schematic view of a position corresponding to the X-X arrow in FIG. 1. As shown in these figures, a bumper 40, which is an exterior component, is attached to the front end of the vehicle body, and a radar device 30 (object detection device) is disposed on the back side (rear side) of the bumper 40, and a cover member 50 is provided to cover the front side of the radar device 30. The cover member 50 is disposed in an opening 41 provided in a part of the bumper 40 and integrally connected with the bumper 40. Specifically, the radar device 30 and the cover member 50 are disposed at a position below (directly below) a right headlight unit 70 at the front end of the vehicle body (a position near the right corner of the bumper 40). Although FIG. 1 shows only the radar device 30 and the cover member 50 on the right side, the vehicle body is also provided with a radar device and a cover member on the left side. The left radar device and the cover member have a symmetrical configuration with the right radar device 30 and the cover member 50 shown in FIG. 1, so illustration and description thereof will be omitted.

As shown in FIG. 2, the protection structure of the radar device 30 includes: the radar device (object detection device) 30 attached to a vehicle body frame 10 via a support member (bracket) 20; a bumper 40, which is an exterior component of the vehicle and is provided on the front side of the vehicle with respect to the radar device 30 (a direction in which a radar is emitted by the radar device 30, that is, a first direction that is an object detection direction); and the cover member 50 that covers the front of the radar device 30. A dotted line L shown in FIG. 2 is a line indicating a range in which the radar device 30 may detect an object.

Further, in the protection structure of this embodiment, the cover member 50 covering the radar device 30 is provided at a position above a load input part to the bumper 40 (the position at which an obstacle collides with the bumper 40) in a vehicle light collision test.

The support member 20 that supports the radar device 30 includes a leg part 21 fixed to a front surface 10a of the vehicle body frame 10 and a mounting part 22 provided at the tip of the leg part 21, and the radar device 30 is attached to the mounting part 22. In this way, the radar device 30 is supported at a position protruding forward of the vehicle body from the vehicle body frame 10. The radar device 30 supported by the support member 20 is disposed between the vehicle body frame 10 and the bumper 40 in the front-rear direction of the vehicle body.

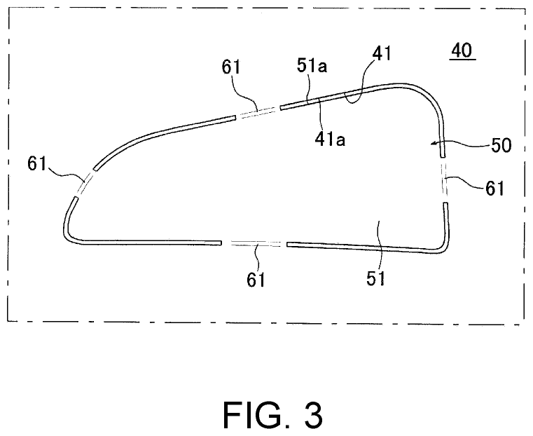

The cover member 50 includes a base part 51 connected to the bumper 40 and an extension part (side wall part) 52 extending from the base part 51 toward the rear of the vehicle body (second direction opposite to the first direction). The base part 51 of the cover member 50 is a substantially flat plate-shaped part, and is disposed so as to be continuous with a peripheral edge 41a (see FIG. 3) of the opening 41 that is a part of the bumper 40. The extension part 52 is a plate-shaped part that extends from a peripheral edge 51a of the base part 51 toward the vehicle body frame 10 (toward the rear side of the vehicle body), and is formed as an annular tubular part that surrounds the radar device 30 and the support member 20. That is, the extension part 52 of the cover member 50 is a tubular part disposed around the support member 20 and the radar device 30. As a whole, the cover member 50 is formed in the shape of a bottomed container having the base part 51 as a bottom wall and the extension part 52 as an annular side wall. Here, by forming the extension part 52 in an annular shape to form a tubular side wall surrounding the entire periphery of the radar device 30, the radar device 30 may also be provided with a drip-proof effect. The term “tubular” as used herein is not limited to a shape in which the entire periphery of the radar device 30 is surrounded by the extension part 52 formed in an annular shape; for example, a case where a slit is provided in a part of the side wall considering the handling of the radar device 30 may also be included. In addition, the extension part 52 may be configured by multiple, for example, four flat plate-shaped members disposed on the four sides of the radar device 30 on the top, bottom, left, and right sides.

The length L1 of the extension part 52 is set to be longer than the length L2 from the front surface 10a of the vehicle body frame 10 to an end (end surface) 30a of the radar device 30 on the side of the base part 51 (L1>L2). In addition, the smallest gap (S1) in the gap from the base part 51 to the end 30a on the side of the base part 51 of the radar device 30 toward the rear (second direction) of the vehicle is configured to be larger than the gap (S2) from a tip (rear end) 52a of the extension part 52 to the vehicle body frame 10 toward the rear (second direction) of the vehicle (S1>S2).

The tip 52a of the extension part 52 of the cover member 50 abuts on at least part of the surroundings of the radar device 30 and the support member 20 on the vehicle body frame 10.

The bumper 40 is a synthetic resin molded product, and the cover member 50 is also a synthetic resin molded product made of the same material as the bumper 40. The color of the cover member 50 (the front surface of the base part 51) may be the same as the color of the bumper 40 (vehicle body color), or may be a different color (such as black).

FIG. 3 is a partially enlarged view of the Y part of FIG. 1. As shown in the figure, a connection part 61 connects the peripheral edge (outer edge) 51a of the base part 51 of the cover member 50 and the peripheral edge (inner edge) 41a of the opening 41 of the bumper 40. The connection part 61 is a part (breaking part) configured to be broken when the bumper 40 and the base part 51 of the cover member 50 are relatively displaced by a predetermined amount or more. That is, as shown in the figure, it is possible to adopt a configuration in which the peripheral edge (outer edge) 51a of the base part 51 of the cover member 50 and the peripheral edge (inner edge) 41a of the opening 41 of the bumper 40 face each other with a slight gap therebetween, and they are connected by the connection parts 61 provided at multiple locations. In this case, it is desirable to provide the connection parts 61 at two or more locations (four locations in the shown example) on the periphery of the base part 51. Further, the thickness of the connection part 61 is set to be smaller than the thickness of the bumper 40 and the thickness of the base part 51, for example, so that the connection part 61 is set to have a strength such that it is appropriately broken along with the relative displacement between the base part 51 and the bumper 40.

Further, although illustration and detailed description are omitted, the connection part 61 may be formed by, for example, a connection structure by fitting claws, a connection structure by a clip, or the like, in addition to the above structure, as long as the peripheral edge (outer edge) 51a of the base part 51 of the cover member 50 and the peripheral edge (inner edge) 41a of the opening 41 of the bumper 40 are separably connected.

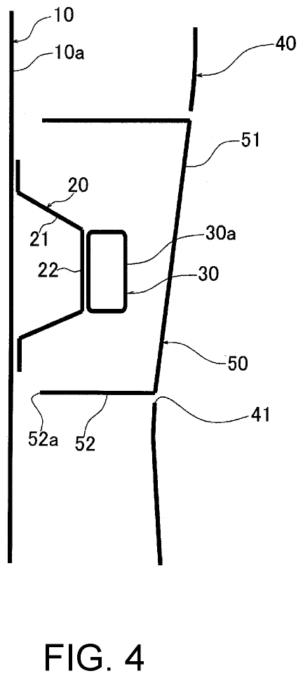

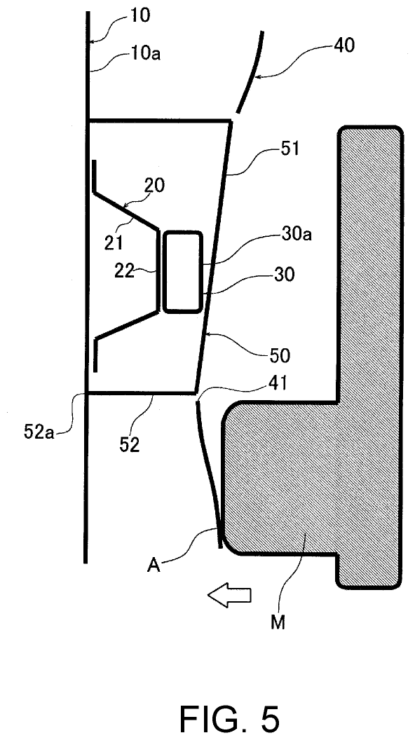

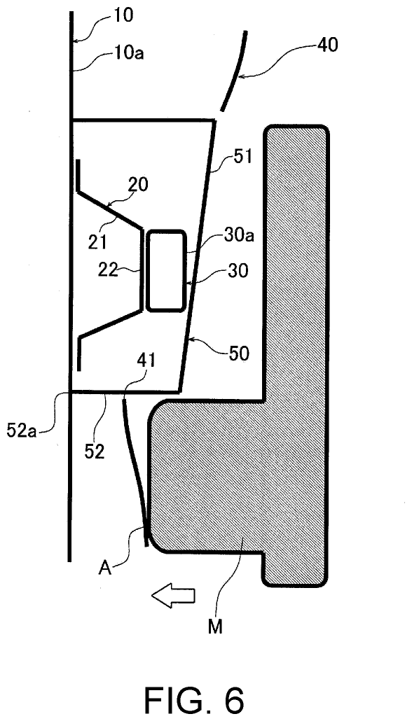

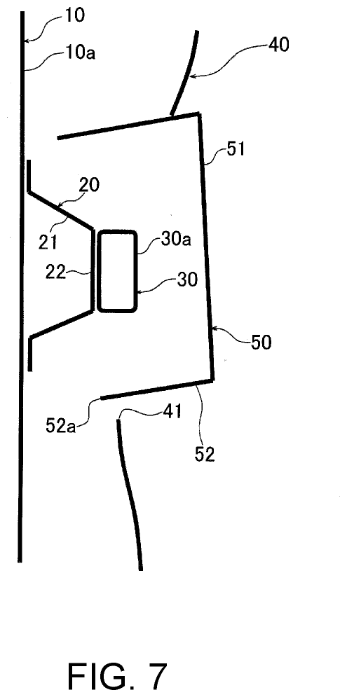

Next, the operation of the protection structure of the radar device 30 having the above configuration will be described. FIGS. 4 to 7 are views for illustrating the case where an external force acts on the bumper 40 during a light collision of the vehicle. FIG. 4 is a view showing a state immediately before the light collision. FIG. 5 is a view showing a state at the time of impact in the light collision. FIG. 6 is a view showing a state at the time of maximum displacement of the bumper in the light collision. FIG. 7 is a view showing a state immediately after the light collision. It should be noted that the term “light collision” as used herein refers to the case where the vehicle body suffers damage due to a relatively minor collision, such as a case where a part of the bumper 40 collides with an external obstacle such as when the vehicle is traveling at a relatively low speed, and the bumper 40 is slightly displaced or deformed, and a case where the bumper 40 is detached from the vehicle body, and the like. In other words, for the collision in this case, it assumes a minor collision that does not affect a wide area of the front of the vehicle, such as damage or deformation, but affects only the bumper 40 or a limited area around the bumper 40.

Here, as shown in FIG. 5, an external obstacle M collides with a position (collision point) A below the radar device 30 and the cover member 50 in the bumper 40. In this case, as shown in the figure, due to the collision of the obstacle M with the bumper 40, the collision point A and its surrounding part of the bumper 40 are displaced (moved) toward the rear side of the vehicle body (toward the radar device 30 and the vehicle body frame 10 side). In this way, the cover member 50 connected to the bumper 40 is also displaced in the same direction together with the bumper 40.

Then, as shown in the figure, the extension part 52 (the tip 52a thereof) of the cover member 50 contacts the front surface 10a of the vehicle body frame 10. When the bumper 40 is further displaced in the same direction from there, since the tip 52a of the extension part 52 is in contact with the vehicle body frame 10, it cannot be displaced further to the rear side of the vehicle body, and only the bumper 40 is displaced in the rearward direction of the vehicle body. When the bumper 40 and the base part 51 of the cover member 50 are relatively displaced by a predetermined amount or more in this way, as shown in FIG. 6, the connection between the bumper 40 and the base part 51 of the cover member 50 is released by breaking the connection part 61 connecting the base part 51 of the cover member 50 and the bumper 40. In this way, it is possible to prevent the cover member 50 from contacting the radar device 30 or the support member 20 even when the bumper 40 is displaced by an external force due to a light collision of the vehicle. Furthermore, since the radar device 30 and the support member 20 may be protected by the cover member 50, the contact of the bumper 40 and other members with the radar device 30 or the support member 20 may be more reliably prevented.

Further, in this case, the cover member 50 is separated from the bumper 40 by breaking the connection part 61, but even in this case, the cover member 50 is provided with the tubular extension part 52, and the extension part 52 functions to prevent the cover member 50 from coming off (from the vehicle body) as shown in FIG. 7. Therefore, it is possible to effectively prevent the cover member 50 from slipping out of the opening 41 of the bumper 40 and falling.

As described above, the protection structure of the radar device 30 of this embodiment includes: the radar device 30 attached to the vehicle body frame 10 via the support member 20; the bumper 40 (exterior component) provided on the front side of the vehicle with respect to the radar device 30 (the first direction that is the object detection direction by the radar device 30); and the cover member 50 connected to the bumper 40 and covering the radar device 30. The cover member 50 includes the base part 51 provided on the front side (first direction) of the radar device 30 and the extension part 52 extending from the base part 51 toward the rear of the vehicle (second direction opposite to the first direction). In addition, the gap S1 from the base part 51 to the end 30a on the side of the base part 51 of the radar device 30 toward the rear (second direction) of the vehicle is configured to be larger than the gap S2 from the tip (rear end) 52a of extension part 52 to the front surface 10a of the vehicle body frame 10 toward the rear (second direction) of the vehicle (S1>S2). Therefore, in this protection structure, it is configured that the extension part 52 (tip 52a) of the cover member 50 abuts on the vehicle body frame 10 when the bumper 40 is displaced toward the rear of the vehicle with respect to the vehicle body frame due 10 to an external force acting on the bumper 40 due to a light collision of the vehicle or the like.

According to the protection structure of the object detection device of this embodiment, because of the configuration as described above, even if the bumper 40 is displaced due to the action of an external force due to a light collision of the vehicle or the like, it is possible to effectively prevent other members such as the bumper 40 from contacting the radar device 30 or the support member 20. Therefore, it is possible to prevent the support member 20 that supports the radar device 30 from being displaced or distorted at the time of a light vehicle collision and to prevent a strong impact from being applied to the radar device 30 with a simple configuration that reduces the number of components.

In addition, in the protection structure of this embodiment, the length L1 of the extension part 52 of the cover member 50 is longer than the length L2 from the vehicle body frame 10 to the end 30a of the radar device 30 on the side of the base part 51 of the cover member 50 (L1>L2).

According to this configuration, when the bumper 40 is displaced toward the rear of the vehicle with respect to the vehicle body frame 10, the extension part 52 (tip 52a) may abut on the vehicle body frame 10 before the base part 51 of the cover member 50 contacts the radar device 30 or the support member 20. Therefore, it is possible to more effectively prevent other members such as the bumper 40 from contacting the radar device 30 or the support member 20 with a relatively simple configuration.

In addition, in the protection structure of this embodiment, it is configured that the extension part 52 (tip 52a) of the cover member 50 abuts on the vehicle body frame 10 when the bumper 40 is displaced toward the rear of the vehicle, whereby the connection between the bumper 40 and the base part 51 of the cover member 50 is released.

According to this configuration, even if the bumper 40 is displaced by an external force due to a light collision of the vehicle, the amount of displacement of the cover member 50 may be suppressed by releasing the connection between the bumper 40 and the base part 51 of the cover member 50. Therefore, it is possible to more effectively prevent the cover member 50 from contacting the radar device 30 or the support member 20.

In addition, in the protection structure of this embodiment, the connection part 61 between the bumper 40 and the base part 51 of the cover member 50 is a part configured to be broken when the bumper 40 and the base part 51 of the cover member 50 are relatively displaced by a predetermined amount or more.

According to this configuration, when the bumper 40 and the base part 51 of the cover member 50 are relatively displaced by a predetermined amount or more, the connection part 61 between the bumper 40 and the base part 51 of the cover member 50 is broken. Therefore, it is possible to more reliably prevent the cover member 50 from contacting the radar device 30 or the support member 20 even when the bumper 40 is displaced by an external force due to a light collision of the vehicle.

In addition, in the protection structure of this embodiment, the extension part 52 (tip 52a) of the cover member 50 abuts on the surroundings of the radar device 30 and the support member 20 on the vehicle body frame 10.

According to this configuration, the extension part 52 (tip 52a) abuts on the surroundings of the radar device 30 and the support member 20 on the vehicle body frame 10, whereby it is possible to more reliably prevent the extension part 52 (tip 52a) and the base part 51 of the cover member 50 from contacting the radar device 30 and the support member 20.

Further, in the protection structure of this embodiment, the radar device 30 and the cover member 50 covering the radar device 30 are provided at positions above a load input part to the bumper 40 (the position at which an obstacle collides with the bumper 40) in a vehicle light collision test.

According to this configuration, since the cover member 50 is provided at a position above the load input part to the bumper 40 in the vehicle light collision test, it is possible to effectively reduce the possibility that an external force acts directly on the cover member 50 at the time of a light collision of the vehicle. Therefore, it is possible to more reliably prevent the cover member 50 from contacting the radar device 30 or the support member 20.

Further, in the protection structure of this embodiment, the extension part 52 of the cover member 50 is a tubular part disposed around the support member 20 and the radar device 30.

According to this configuration, since the radar device 30 and the support member 20 are surrounded by the extension part 52 of the cover member 50, the radar device 30 and the support member 20 may be effectively protected by the cover member 50. Therefore, even if the bumper 40 is displaced by an external force due to a light vehicle collision, it is possible to more reliably prevent other members such as the bumper 40 from contacting the radar device 30 or the support member 20. In addition, the extension part 52 of the cover member 50 may be expected to have the effect of preventing the cover member 50, which has been separated from the bumper 40, from completely detaching from the vehicle body and falling off at the time of a light collision of the vehicle.

In addition, in the protection structure of this embodiment, the base part 51 of the cover member 50 is disposed inside the opening 41 provided in the bumper 40 and configures a part of the bumper 40.

According to this configuration, since the cover member 50 that covers the radar device 30 configures a part of the bumper 40, even if the radar device 30 is disposed at a position at the same height as the bumper 40 (a relatively lower position on the vehicle), it is possible to prevent other members from contacting the radar device 30 and the support member 20 due to the impact of a light collision; therefore, it is possible to dispose the radar device 30 at a position closer to the bumper 40 (a position where the distance in the front-rear direction of the vehicle body is shorter). Therefore, it is possible to improve the design of the vehicle body including the bumper 40 and improve the object detection performance of the radar device 30 while maintaining the structure that may effectively protect the radar device 30 and the support member 20 at the time of a light vehicle collision.

Although the embodiments of the disclosure have been described above, the disclosure is not limited to the above embodiments, and various modifications may be made within the scope of the technical ideas described in the claims, the specification and the drawings. For example, in the above embodiments, the cover member covers the entire radar device, but in addition to this, the cover member according to the disclosure may be configured to cover only a part of the radar device. Further, in the above embodiments, the base part of the cover member is disposed inside the opening provided in the bumper, but in addition to this, the cover member may be provided inside a notch or the like formed in the bumper.

What is claimed is:

1. A protection structure of an object detection device of a vehicle, comprising:
the object detection device attached to a vehicle body frame via a support member;
an exterior component of the vehicle provided in a first direction, which is an object detection direction by the object detection device with respect to the object detection device; and
a cover member connected to the exterior component and covering at least a part of the object detection device,
wherein the cover member comprises:
a base part provided in the first direction with respect to the object detection device; and
an extension part extending from the base part in a second direction opposite to the first direction,
a gap in the second direction from the base part to the object detection device is configured to be larger than a gap in the second direction from an end of the extension part in the second direction to the vehicle body frame, and
the extension part is configured to abut on the vehicle body frame in response to the exterior component being displaced in the second direction with respect to the vehicle body frame due to an action of an external force.

2. The protection structure of the object detection device of the vehicle according to claim 1, wherein a length of the extension part is longer than a length from the vehicle body frame to an end on the base part side of the object detection device.

3. The protection structure of the object detection device of the vehicle according to claim 1, wherein connection between the exterior component and the base part of the cover member is released when the extension part abuts on the vehicle body frame in response to the exterior component being displaced in the second direction.

4. The protection structure of the object detection device of the vehicle according to claim 2, wherein connection between the exterior component and the base part of the cover member is released when the extension part abuts on the vehicle body frame in response to the exterior component being displaced in the second direction.

5. The protection structure of the object detection device of the vehicle according to claim 1, wherein a connection part that connects the exterior component and the base part of the cover member is a part configured to be broken in response to the exterior component and the base part of the cover member being relatively displaced by a predetermined amount or more.

6. The protection structure of the object detection device of the vehicle according to claim 2, wherein a connection part that connects the exterior component and the base part of the cover member is a part configured to be broken in response to the exterior component and the base part of the cover member being relatively displaced by a predetermined amount or more.

7. The protection structure of the object detection device of the vehicle according to claim 3, wherein a connection part that connects the exterior component and the base part of the cover member is a part configured to be broken in response to the exterior component and the base part of the cover member being relatively displaced by a predetermined amount or more.

8. The protection structure of the object detection device of the vehicle according to claim 4, wherein a connection part that connects the exterior component and the base part of the cover member is a part configured to be broken in response to the exterior component and the base part of the cover member being relatively displaced by a predetermined amount or more.

9. The protection structure of the object detection device of the vehicle according to claim 1, wherein the extension part abuts on at least a part of surroundings of the object detection device and the support member on the vehicle body frame.

10. The protection structure of the object detection device of the vehicle according to claim 2, wherein the extension part abuts on at least a part of surroundings of the object detection device and the support member on the vehicle body frame.

11. The protection structure of the object detection device of the vehicle according to claim 3, wherein the extension part abuts on at least a part of surroundings of the object detection device and the support member on the vehicle body frame.

12. The protection structure of the object detection device of the vehicle according to claim 4, wherein the extension part abuts on at least a part of surroundings of the object detection device and the support member on the vehicle body frame.

13. The protection structure of the object detection device of the vehicle according to claim 5, wherein the extension part abuts on at least a part of surroundings of the object detection device and the support member on the vehicle body frame.

14. The protection structure of the object detection device of the vehicle according to claim 6, wherein the extension part abuts on at least a part of surroundings of the object detection device and the support member on the vehicle body frame.

15. The protection structure of the object detection device of the vehicle according to claim 7, wherein the extension part abuts on at least a part of surroundings of the object detection device and the support member on the vehicle body frame.

16. The protection structure of the object detection device of the vehicle according to claim 8, wherein the extension part abuts on at least a part of surroundings of the object detection device and the support member on the vehicle body frame.

17. The protection structure of the object detection device of the vehicle according to claim 1, wherein the cover member is provided at a position above a load input part to the exterior component in a light collision test of the vehicle.

18. The protection structure of the object detection device of the vehicle according to claim 2, wherein the cover member is provided at a position above a load input part to the exterior component in a light collision test of the vehicle.

19. The protection structure of the object detection device of the vehicle according to claim 1, wherein the extension part of the cover member is a tubular part disposed around the support member and the object detection device.

20. The protection structure of the object detection device of the vehicle according to claim 1, wherein the exterior component is a bumper of the vehicle, and
at least a part of the cover member is disposed inside an opening or a notch provided in the bumper, and configures a part of the bumper.
